(19) United States
(12) Patent Application Publication
(10) Pub. No.: US 2011/0213047 A1
(43) Pub. Date: Sep. 1, 2011

(54) Non-flammable composition which can be used as a blowing agent

(76) Inventor: Laurent Caron, Sainte Foy Les Lyon (FR)

(21) Appl. No.: 10/593,944

(22) PCT Filed: Mar. 15, 2005
(86) PCT No.: PCT/FR2005/000615

§ 371 Date: Oct. 6, 2006

(30) Foreign Application Priority Data
Apr. 6, 2004 (FR) 0403593

(51) Int. Cl. C08J 9/14; C09K 3/00; C09K 5/04; C09K 3/30; C08G 18/72

(52) U.S. Cl. 521/131; 252/182.15; 252/67; 252/364

(57) ABSTRACT

The present invention relates to compositions which can be used as expanding agent in the manufacture of thermosetting polymers. A more particular subject-matter of the invention is compositions comprising 1,1,1,3,3-pentafluorobutane (365mfc), trans-1,2-dichloroethylene and at least one nonflammable hydrofluorocarbon and their use.

The present invention relates to compositions which can be used as expanding agent in the manufacture of thermosetting polymers. A more particular subject-matter of the invention is compositions comprising 1,1,1,3,3-pentafluorobutane (365mfc), trans-1,2-dichloroethylene and at least one nonflammable hydrofluorocarbon and their use.

It is known to use 1,1,1,3,3-pentafluorobutane as expanding agent in the manufacture of foams, for example polyurethane or polyisocyanurate foams. However, because of its flammability, 1,1,1,3,3-pentafluorobutane is used in combination with other compounds, for example 1, 1,1,2-tetrafluoroethane (134a) or 1,1,1,2,3,3,3-heptafluoropropane (227ea) (U.S. Pat. No. 6,080,799). As these compounds have lower boiling points than that of 1,1,1,3,3-pentafluorobutane (365mfc), they present problems in the binary compositions resulting from their combination with 365mfc.

Thus, problems of rise in pressure during storage in hot weather or of change in composition by selective evaporation are often encountered.

In addition, the addition of compounds for reducing the flammability of 365mfc is often more expensive and thus results in an increase in the cost (price) of the expanding agent.

The Applicant Company has now discovered that the addition of trans-1,2-dichloroethylene makes it possible to limit the abovementioned disadvantages and optionally to reduce the content of nonflammable product.

A first subject-matter of the present invention is compositions comprising 1,1,1,3,3-pentafluorobutane (365mfc), trans-1,2-dichloroethylene and at least one compound chosen from 1,1,1,2-tetrafluoroethane (134a) and 1,1,1,2,3,3,3-heptafluoropropane (227ea).

The compositions according to the present invention preferably comprise from 5 to 94% by weight of 365mfc, from 5 to 94% by weight of trans-1,2-dichloroethylene and from 1 to 60% by weight of 134a and/or 227ea.

With 227ea, the more particularly preferred compositions comprise from 50 to 90% by weight of 365mfc, from 5 to 30% of trans-1,2-dichloroethylene and from 2 to 21% by weight of 227ea.

With 134a, the more particularly preferred compositions comprise from 59 to 90% by weight of 365mfc, from 5 to 30% by weight of trans-1,2-dichloroethylene and from 3 to 11% by weight of 134a.

Advantageously, the compositions according to the present invention do not exhibit a flash point under standard determination conditions (ASTM standard D 3828).

Compositions comprising from 5 to 25% by weight of 365mfc, 65 to 90% by weight of trans-1,2-dichloroethylene and from 2 to 20% by weight of 134a and/or 227ea are also interesting. Preferably, composition according to the first subject matter of the present invention do not contain hydrochlorofluorocarbon.

The compositions according to the present invention can be used as expanding agent in the manufacture of thermosetting polymer foams, such as, for example, phenol/formaldehyde condensates or polyurethane. They are very particularly suitable for the manufacture of polyurethane or polyisocyanurate foams.

The second subject-matter of the present invention is an expanding agent for thermosetting polymer foams, characterized in that it comprises 1,1,1,3,3-pentafluorobutane (365mfc), trans-1,2-dichloroethylene and at least one compound chosen from 1,1,1,2-tetrafluoroethane (134a) and 1,1,1,3,3,3-hexafluoropropane (227ea).

The expanding agent according to the present invention preferably comprises from 5 to 94% by weight of 365mfc, from 5 to 94% by weight of trans-1,2-dichloroethylene and from 1 to 60% by weight of 134a and/or 227ea.

The particularly preferred expanding agent comprises from 50 to 90% by weight of 365mfc, from 5 to 30% of trans-1,2-dichloroethylene and from 2 to 21% by weight of 227ea.

The expanding agent comprising from 59 to 90% by weight of 365mfc, from 5 to 30% by weight of trans-1,2-dichloroethylene and from 3 to 11% by weight of 134a is also preferred.

The expanding agent comprising from 5 to 25% by weight of 365mfc, from 65 to 90% by weight of trans-1,2-dichloroethylene and from 2 to 20% by weight of 134a and/or 227ea is also interesting.

Preferably, the expanding agent according to the present invention does not contain hydrochlorofluorocarbon.

The methods for the manufacture of polyurethane or polyisocyanurate foams are generally known and consist in general in reacting an organic polyisocyanate (including the diisocyanate) with a polyol or a mixture of polyols in the presence of an expanding agent.

A third subject-matter of the present invention is a process for the manufacture of polyurethane or polyisocyanurate foams, according to which an organic polyisocyanate (including the diisocyanate) is reacted with a polyol or a mixture of polyols in the presence of an expanding agent according to the second subject-matter.

The amount of expanding agent deployed depends on the density desired for the foams thus manufactured. This amount is generally between 1 and 60 parts by weight per 100 parts by weight of polyol. It is preferably between 10 and 35 parts by weight per 100 parts of polyol.

The reaction between a polyisocyanate and a polyol or a mixture of polyols can be activated using an amine and/or other catalysts and surface-active agents.

Mention may in particular be made, as polyisocyanate, of aliphatic polyisocyanates with a hydrocarbonaceous group which can range up to 18 carbon atoms, cycloaliphatic polyisocyanates with a hydrocarbonaceous group which can range up to 15 carbon atoms, aromatic polyisocyanates with an aromatic hydrocarbonaceous group having from 6 to 15 carbon atoms and arylaliphatic polyisocyanates with an arylaliphatic hydrocarbonaceous group having from 8 to 15 carbon atoms.

The preferred polyisocyanates are 2,4- and 2,6-diisocyanatotoluene, diphenylmethane diisocyanate, polymethylenepolyphenyl isocyanate and their mixtures. Modified polyisocyanates, such as those comprising carbodiimide groups, urethane groups, isocyanurate groups, urea groups or biurea groups, may also be suitable.

Mention may in particular be made, as polyols, of glycerol, ethylene glycol, trimethylolpropane, pentaerythritol, polyetherpolyols, for example those obtained by condensation of an alkylene oxide or a mixture of alkylene oxides with glycerol, ethylene glycol, trimethylolpropane or pentaerythritol, or polyesterpolyols, for example those obtained from polycarboxylic acids, in particular oxalic acid, malonic acid, succinic acid, adipic acid, maleic acid, fumaric acid, isophthalic acid or terephthalic acid, with glycerol, ethylene glycol, trimethylolpropane or pentaerythritol.

The polyetherpolyols obtained by addition of alkylene oxides, in particular ethylene oxide and/or propylene oxide, to aromatic amines, in particular the mixture of 2,4- and 2,6-toluenediamine, are also suitable.

In many applications, the components of the polyurethane or polyisocyanurate foams are premixes. More generally, the formulation of the foams is premixed as two components. The first component, better known under the name “component A”, comprises the isocyanate or polyisocyanate composition. The second component, better known under the name “component B”, comprises the polyol or the mixture of polyols, the surface-active agent, the catalyst(s) and the expanding agent(s).

A fourth subject-matter of the present invention is a composition comprising the polyol and the expanding agent according to the second subject-matter. This composition preferably comprises 100 parts by weight of polyol and from 1 to 60 parts by weight of expanding agent.

Advantageously, the composition according to the fourth subject-matter of the present invention comprises 100 parts by weight of polyol and from 10 to 35 parts by weight of expanding agent, preferably composed essentially of 5 to 94% by weight of 365mfc, of 5 to 94% by weight of trans-1,2-dichloroethylene and of 1 to 60% by weight of 134a and/or 227ea.

The composition comprising 100 parts by weight of polyol and from 10 to 35 parts by weight of expanding agent composed essentially of 5 to 25% by weight of 365mfc, from 65 to 90% by weight of trans-1,2-dichloroethylene and from 2 to 20% by weight of 134a and/or 227ea is also interesting.

The composition according to the fourth subject-matter has the advantage of not exhibiting, within the operating temperature range, a flash point under standard determination conditions (ASTM D 3828). The temperature range is preferably between −30 and 61° C.

The composition according to the fourth subject-matter can additionally comprise a surface-active agent and/or a catalyst.

The compositions according to the first subject-matter of the invention can be used as solvents, aerosols and/or cooling agents.

### EXAMPLES

### Example 1

A composition comprising 86% by weight of 365mfc, 10% by weight of trans-1,2-dichloroethylene and 4% by weight of 227ea is prepared. The flash point of the composition thus prepared is subsequently determined under standard conditions (ASTM standard D 3828) within the temperature range from −30° C. up to the boiling point.

The bubble temperature and the dew temperature of this composition are also determined and the difference between the two temperatures is known under the name “glide”.

In addition, the bubble pressure at 50° C. is determined.

### Results

A flash point is not observed in the temperature range studied, the glide at 1 atmosphere is 4.43 K(C) and the bubble pressure is 1.79 bar.

### Example 2

A composition comprising 77% by weight of 365mfc, 20% by weight of trans-1,2-dichloroethylene and 3% by weight of 227ea is prepared. The flash point of the composition thus prepared is subsequently determined under standard conditions (ASTM standard D 3828) within the temperature range from −30° C. up to the boiling point.

The bubble temperature and the dew temperature of this composition are also determined and the difference between the two temperatures is known under the name “glide”.

In addition, the bubble pressure at 50° C. is determined.

### Results

A flash point is not observed in the temperature range studied, the glide at 1 atmosphere is 3.56 K(C) and the bubble pressure is 1.71 bar.

### Example 3

A composition comprising 25% by weight of 365mfc, 25% by weight of trans-1,2-dichloroethylene and 50% by weight of 134a is prepared. The flash point and the bubble pressure are subsequently determined under the same conditions as in the preceding examples.

### Results

A flash point is not observed in the temperature range studied and the bubble pressure is 6.6 bar.

### Example 4

A composition comprising 50% by weight of 365mfc, 25% by weight of trans-1,2-dichloroethylene and 25% by weight of 134a is prepared.

The flash point and the bubble pressure are subsequently determined under the same conditions as in Example 3.

### Results

A flash point is not observed in the temperature range studied and the bubble pressure is 4.1 bar.

### Example 5

11.2 g of the composition prepared in Example 3 are mixed with 100 g of polyol Stepanpol PS2412 (polyol of polyester type).

The flash point is subsequently determined under standard conditions (ASTM D 3828) within the temperature range from −30° C. to 61° C.

### Result

A flash point is not observed.

### Example 6

12.4 g of the composition prepared in Example 4 are mixed with 100 g of polyol Stepanpol PS2412.

The flash point is subsequently determined under standard conditions (ASTM D 3828) within the temperature range from −30° C. to 61° C.

### Result

A flash point is not observed.

1. Composition comprising 1,1,1,3,3-pentafluorobutane (365mfc), trans-1,2-dichloroethylene and at least one compound chosen from 1,1,1,2-tetrafluoroethane (134a) and 1,1,1,2,3,3,3-heptafluoropropane (227ea).

2. Composition according to claim 1, characterized in that it comprises from 5 to 94% by weight of 365mfc, from 5 to 94% by weight of trans-1,2-dichloroethylene and from 1 to 60% by weight of 134a and/or 227ea.

3. Composition according to claim 1 or 2, characterized in that it comprises from 50 to 90% by weight of 365mfc, from 5 to 30% of trans-1,2-dichloroethylene and from 2 to 21% by weight of 227ea.

4. Composition according to claim 1 or 2, characterized in that it comprises from 59 to 90% by weight of 365mfc, from 5 to 30% by weight of trans-1,2-dichloroethylene and from 3 to 11% by weight of 134a.

5. Composition according to claim 1 or 2, characterized in that it comprises from 5 to 25% by weight of 365mfc, from 65 to 90% by weight of trans-1,2-dichloroethylene and from 2 to 20% by weight of 134a and/or 227ea.

6. Expanding agent, characterized in that it is composed of a composition according to any one of the preceding claims.

7. Process for the manufacture of thermosetting polymer foams, characterized in that use is made of an expanding agent according to claim 5.

8. Process according to claim 6, characterized in that a polyisocyanate is reacted with a polyol or mixture of polyols.

9. Composition according to any one of claims 1 to 4, characterized in that it additionally comprises a polyol.

10. Composition according to any one of claims 1 to 4, characterized in that it is used as solvents, aerosols and/or cooling agents.
